(19) United States
(12) Patent Application Publication
(10) Pub. No.: US 2014/0082369 A1
(43) Pub. Date: Mar. 20, 2014

(54) Method and System For Object Access and Usage Control Using Location and Access Boundary Shape Information

(71) Applicant: FUTURWEI TECHNOLOGIES INC., Dallas, TX (US)

(72) Inventors: John Waclawsky, Bartlett, IL (US); Zhengyi Le, Redwood City, CA (US)

(73) Assignee: Futurwei Technologies Inc., Dallas, TX (US)

(21) Appl. No.: 13/623,457

(22) Filed: Sep. 20, 2012

(51) Int. Cl. G06F 21/24

(52) U.S. Cl. 713/189; 726/27

(57) ABSTRACT

A method and a system for shape based encrypted object usage control using a querying device includes receiving location coordinates information and requesting an access to the encrypted object based on the received location coordinates information. The granting or denying access to the object is based on a determination of whether the received location coordinates information lies within at least one spatial access boundary. The at least one spatial access boundary is defined by an arbitrary physical object shape with at least two dimensional (2D) physical measurements in direct reference to designated location coordinates information. The received location coordinates information and the designated location coordinates information each includes longitude, latitude and optionally elevation values which provide the ability to identifying a specific location in a 3D space.

### FIELD OF THE TECHNOLOGY

The present application relates to the field of digital information security. More particularly the application provides a method and system to control object usage or access to an object by encrypting the object with location and pre-defined spatial access boundary information to restrict its access.

### BACKGROUND

Access to a protected object such as protected information either locally stored in a smart device or in a database through a secured network is commonly protected. Accessing the protected object may require authenticating a user's identity (ID) (e.g., user's name) and a valid password. In conjunction with authenticating a valid user's ID and a valid password, added security may be achieved through inputting embedded codes pre-stored or randomly generated within a hardware device (e.g., a smart chip or a random code generator in a hardware key). These security measures (i.e., user ID, password, hardware key) all aim at ensuring that an authorized user is allowed to access the protected object. Nevertheless, a hacker who has possession of the stolen or lost hardware key could possibly remotely at anywhere, gain access to the protected object by utilizing sophisticated code cracking algorithms which run on a high speed computing device.

### SUMMARY

The disclosure addresses the above security concerns by further restricting access to the protected object (i.e., encrypted object) based on received location coordinates information. The location may be at home, at school, at the work place, at a conference site or anywhere which has been pre-designated as permissible access request locations. Furthermore, the disclosure discloses a provision of added access restriction to include pre-defined spatial access boundary information, which is defined by an arbitrary physical object shape with at least two dimensional (2D) physical measurements, wherein the physical measurements are in direct reference to designated location coordinates information. The received location coordinates information and the designated location coordinates information each includes latitude, longitude and elevation values (which provides a vertical capability to identify areas, such as the particular floor of a building). In this regard, access to the encrypted object may be denied once the point of access request has moved outside the envelope of the designated access boundary and location coordinates.

In a first aspect, a method for controlling access to an encrypted object includes a querying device having at least one processor coupled to a memory to perform functions of receiving location coordinates information of the querying device; requesting an access to the encrypted object in accordance to the received location coordinates information; and granting or denying access to the encrypted object based on a determination of whether the received location coordinates information lies within at least one spatial access boundary, wherein: the at least one spatial access boundary is defined by an arbitrary physical object shape with at least two dimensional (2D) physical measurements, wherein the physical measurements are in direct reference to designated location coordinates information, wherein the received location coordinates information and the designated location coordinates information each includes longitude, latitude and elevation values (the combination these three values can define a location in 3D space).

In a second aspect, the disclosure discloses a device for controlling access to an encrypted object, which includes: a querying circuit having at least one processor coupled to a first memory, wherein the at least one processor is configured to: receive location coordinates information; receive request for access to the encrypted object based on the received location coordinates information; and grant or deny access to the encrypted object based on a determination of whether the received location coordinates information lies within at least one spatial access boundary, wherein: the at least one spatial access boundary is defined by an arbitrary physical object shape with at least two dimensional (2D) physical measurements in direct reference to designated location coordinates information, and wherein the received location coordinates information and the designated location coordinates information each includes latitude, longitude and elevation values.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1 depicts an exemplary encrypted object access request environment according to an embodiment;

FIG. 2A depicts an exemplary querying device used in FIG. 1 to access an encrypted object according to an embodiment;

FIG. 2B depicts an exemplary server used in FIG. 1 to encrypt an object according to an embodiment;

FIG. 3 depicts an exemplary location coordinates information received in a querying device when making a request to access the encrypted object according to an embodiment;

FIG. 4 depicts multiple designated locations authorized to access the encrypted object according to an embodiment;

FIG. 5A depicts an exemplary spatial access boundary, which may be defined by an arbitrary physical shape with at least two dimensional (2D) physical measurements in direct reference to designated location coordinates information to access an encrypted object according to an embodiment;

FIG. 5B-5C depicts several exemplary spatial access boundaries, which are defined by an arbitrary physical object shape with two dimensional (2D) physical measurements in direct reference to designated location coordinates information to access an encrypted object according to an embodiment;

FIG. 5D depicts an exemplary spatial access boundary, which is defined by an arbitrary physical object shape with three dimensional (3D) physical measurements in direct reference to designated location coordinates information to access an encrypted object according to an embodiment;

FIG. 6A is a flow chart, which depicts exemplary steps for encrypting an object based on at least designated location coordinates information and spatial boundary object shape information, according to an embodiment of the present disclosure; and

FIG. 6B is a flow chart, which depicts exemplary steps for accessing an encrypted object based on at least designated location coordinates information and spatial access boundary information, according to an embodiment of the present disclosure.

### DETAILED DESCRIPTION OF THE EMBODIMENTS

The problems described above are overcome by providing a method and system for object access and usage control using location and boundary shape information and object boundary information. The system enables an encrypted object to be accessed or used at designated permissible location, where the access boundary is further limited by defining a spatial boundary shape in direct reference to designated location coordinates information.

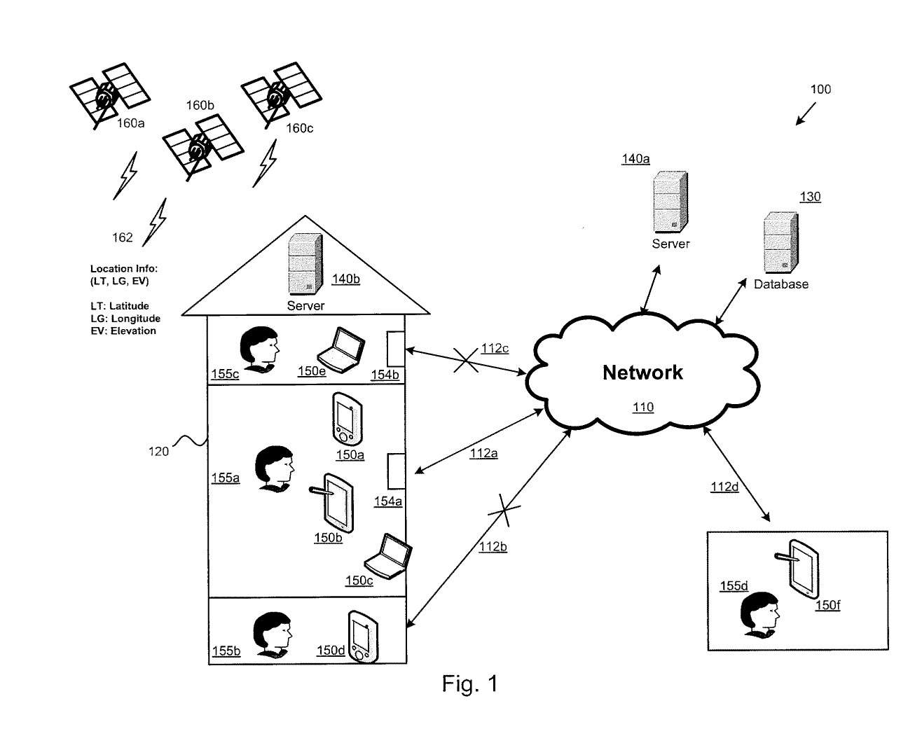

FIG. 1 depicts an exemplary encrypted object access request environment (100) according to an embodiment. More specifically, the disclosure may be implemented in an environment (100) which may be a home environment, a work place, a university, a job site, a conference hall, a hospital or even at lower earth orbits as long as location coordinates information (162) may be received with sufficient accuracy as designated access locations.

In an embodiment, one or more users may make requests (112a-112d) to use or access one or more encrypted objects through a querying device (150a-150f) at different locations (i.e., 155a-155d), either locally or remotely through a network (110). The network (110) may be a combination of existing wired and wireless hybrid network infrastructure interconnected together, which may include a local area network (LAN), a wide area network (WAN) or a cellular network, which supports multi-channel communication formats such as voice, text and video through known communication protocols.

In an embodiment, the location coordinates information (162) may be received through synchronized Global Position System (GPS) satellites (160a to 160c). The location coordinates information (162) may include latitude (LT), longitude (LG) and elevation (EV) coordinates information, which may be received by a querying device (150a-150f) using a GPS receiver or embedded GPS technology in a device chip.

The querying device (150a-150f) may be any communication device which is enabled to access the network (110) and to receive location coordinates information (162). The querying device (150a-150f) may also communicate to a local network device (154a-154b) which is enabled both to receive location coordinates (162) information as well as communicating to the network (110).

In an embodiment, the querying device may be a smart phone (150a, 150d), a smart communication tablet (150b, 150f) or a laptop or notebook computer (150c, 150e). The querying device may also be any electronic widget, a handheld game device, a network device, a vault, a test instrument, a smart weapon, a piece of equipment or a machine.

In an embodiment, an object may be one or more of: an electronic document, multimedia data, an application program, an executable file, a graphical user interface, or any digital information stored within the querying device (150a to 150f), or stored remotely in a database (130). In addition, the object may be data generated by a server (140a, 140b). Therefore, the object may be accessed locally within the querying device (150a-150e) or accessed through the network (110).

Referring to FIG. 1, an object such as a data file may be stored in an offsite database (130) or a server (140a). The object may be encrypted with location coordinates information and pre-defined spatial boundary information to restrict its access to a user at only locations (155a, 155d). The same user who is at location (155b) or (155c) (e.g., a floor below or above location (155a)), while sharing the same longitude (LG) and latitude (LT) location coordinates information (162) as location (155a), may nevertheless, not be permitted to access the encrypted object by virtue of having a different elevation coordinate (EV) information.

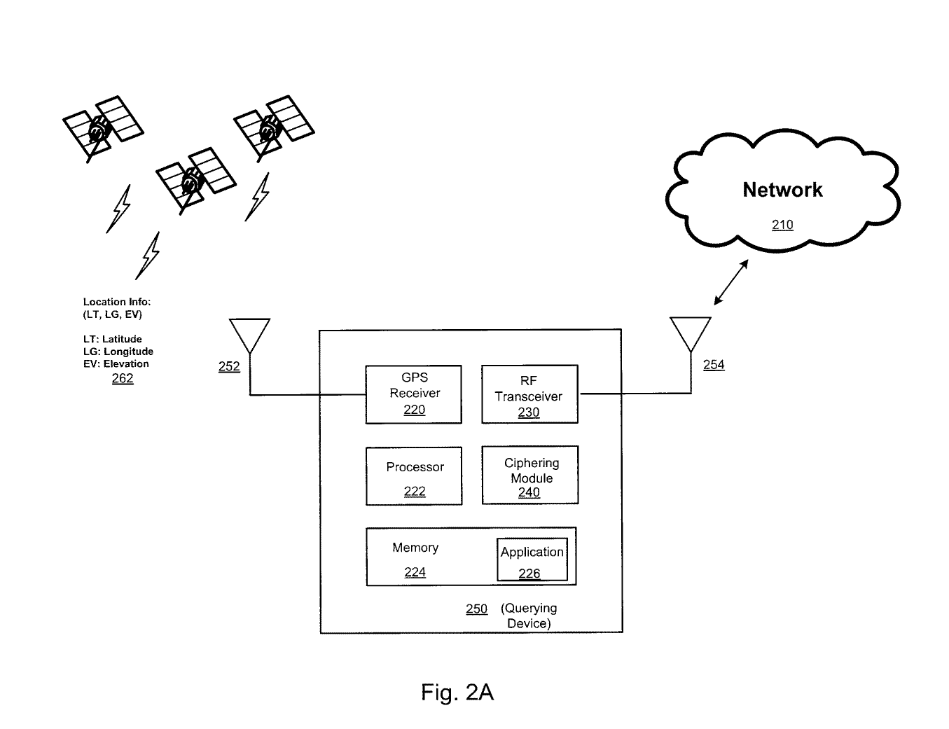

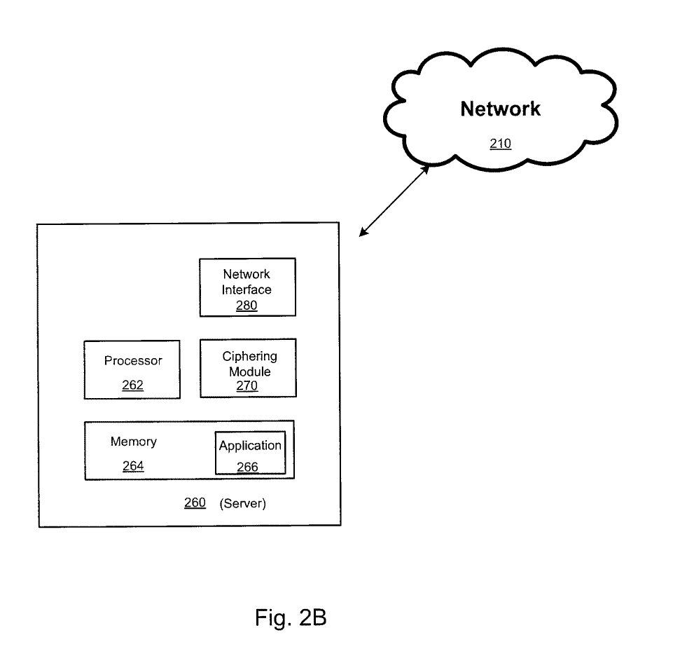

FIG. 2A depicts an exemplary querying device (250) in FIG. 1, which is used to access an encrypted object according to an embodiment. The querying device (250) may include at least a GPS receiver (220), a RF transceiver (230), a processor (222), a memory (224), one or more application (226), and a ciphering module (240).

The GPS receiver (220) may include circuitry and codes which may be coupled to antenna (252) to receive latitude (LT), longitude (LG) and elevation (EV) location coordinates information (262). The RF transceiver (230) may include circuitry and codes which may be coupled to antenna (254) to communicate to a network (210) through an access point or a base station (not shown). The network (210) may be a combination of existing wired and wireless hybrid network infrastructure interconnected together, which may include a local area network (LAN), a wide area network (WAN) or a cellular network, which supports multi-channel communication formats such as voice, text and video through known communication protocols.

In another embodiment, the GPS receiver (220) and the RF transceiver (254) may share the same antenna. Yet in another embodiment, the GPS receiver (220) and the RF transceiver (230) may be integrated into a single chip.

The processor (222) may include a CPU, an application-specific integrated circuit (ASIC) chip, or other hardware processors which may include circuitry and codes enabled to control various functions and process various signals received or generated by the querying device (250). The processor (222) may be coupled to a memory (224). The memory (224) may include at least a ROM for storing system boot up instructions, system configuration data and a security key which may be essential for the operation of the ciphering module (240). In addition, the memory may include one or more cache memory for storing temporary data or operation instructions during processing, and at least a DRAM as a host memory for storing data and one or more application (226). Furthermore, a disk drive or a removable flash memory may be included in the memory (224), if needed for the operation of the querying device (250).

The ciphering module (240) may include circuitry and codes which is enabled to perform key generation, encryption and decryption functions on an object using known security encryption and decryption algorithms. At least one or more application programs (226) stored in the memory (224) includes program codes which may be executed to perform the functions of encrypted object access request.

FIG. 2B depicts an exemplary server (260) similar to the server (140a) used in FIG. 1 to encrypt or decrypt an object according to an embodiment. In an embodiment, the server (260) may include at least a network interface (280), a processor (262), a memory (264), one or more applications (266), and a ciphering module (270).

The network interface (280) may include at least a network interface card with at least a processor, circuitry and codes which facilitates communication to a network (210) through an access point or a base station (not shown). The network interface (280) may utilize known network protocols or communication standards (such as TCP/IP, IEEE 802.11(a, b, g), 802.16, LTE, 3GPP, to name a few) to communicate with the network (210). The network (210) may be a combination of existing wired and wireless hybrid network infrastructure interconnected together, which may include a local area network (LAN), a wide area network (WAN) or a cellular network, which supports multi-channel communication formats such as voice, text and video through known communication protocols.

The processor (262) may include a CPU, an ASIC chip, or other hardware processors which may include circuitry and codes enabled to control various functions and process various signals received or generated by the server (260). The processor (262) may be coupled to a memory (224). The memory (264) may include at least a ROM for storing system boot up instructions, system configuration data and a security key which are essential for the operation of the processor (262) and the ciphering module (270). In addition, the memory may include one or more cache memory for storing temporary data or operation instructions during processing, and at least a DRAM or RAID disks may be used as host memory for storing data and the one or more application (266). In addition, the server (260) may utilize a remote database such as the database (130) of FIG. 1 to store or retrieve data, such as the encrypted object or one or more encryption key through the network (210).

The ciphering module (270) may include circuitry and codes which is enabled to perform key generation, encryption and decryption functions on an object using known security encryption and decryption algorithms. At least one or more application programs (266) stored in the memory (264) includes program codes which may be executed to perform the functions of granting or denying an encrypted object access request.

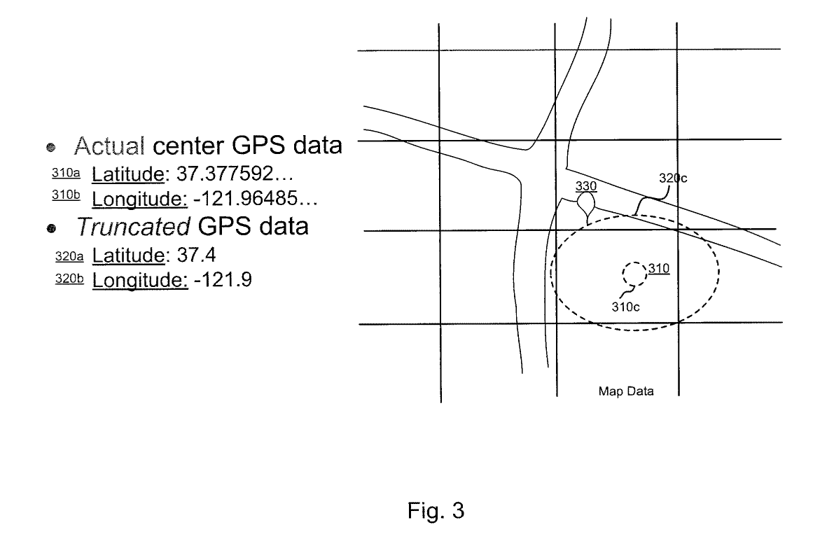

FIG. 3 depicts an exemplary location coordinates information received in a querying device when making a request to access the encrypted object according to an embodiment. In an embodiment, assuming that elevation reading is not a requirement to access the encrypted object, an object may be encrypted with location coordinates information having a latitude reading (310a) of 37.377592 . . . and a longitude reading (310b) of −121.96485 . . . . In this regard, a user with a querying device at location (310) may be granted access to the encrypted object.

It should be noted that the encrypted location coordinates information with the latitude reading (310a) of 37.377592 . . . and the longitude reading (310b) of −121.96485 . . . may define a relatively narrow access range (310c) (see small circle at the center). Therefore, a user at location 330 may not be granted access to the encrypted object unless the encrypted object's location coordinates information has been truncated to. For example, the truncated encrypted object's location coordinates information may use a latitude reading of 37.4 (320a) and a longitude reading of −121.9 (320b), which define an expanded elliptical access range (320c). As seen, the shape of the access range (320c) may be controlled during object encryption, or at any time after the object has been encrypted, simply by increasing or decreasing the resolution (i.e., the number of significant places after the decimal) of the location coordinates information (i.e., LT, LG or EV) independently.

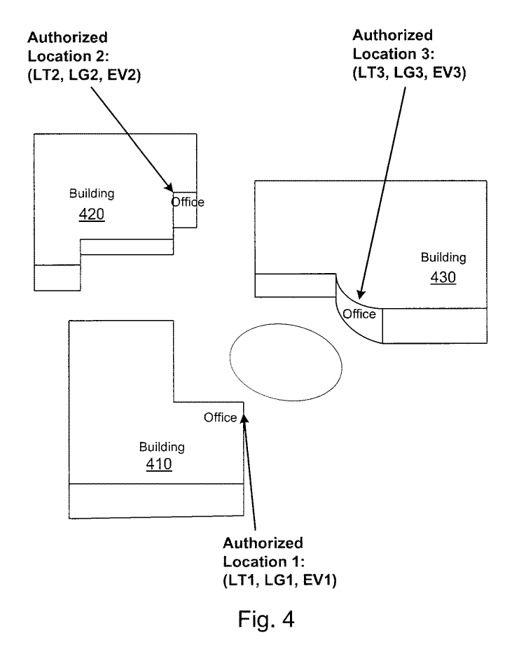

FIG. 4 depicts multiple designated locations authorized to access the encrypted object according to an embodiment. An object may be encrypted to designate multiple authorized locations (e.g., location 1 to 3), which may be designated offices located in buildings 410, 420 and 430, respectively. More specifically, respective location coordinates information for the three locations (LT1, LG1, EV1, LT2, LG2, EV2 and LT3, LG3, EV3) may be included during object encryption.

In addition to using designated location coordinates information (i.e., LT, LG and EV) to encrypt an object, an additional parameter, namely, a two-dimensional (2D) or a three-dimentional (3D) spatial access boundary may be added to encrypt the object which further limits its access location. More specifically, the 2D or 3D spatial access boundary may be defined by an arbitrary physical shape (in 2D or 3D) with physical measurements in direct reference to the designated location coordinates information (i.e., LT, LG and EV) to access the encrypted object according to an embodiment.

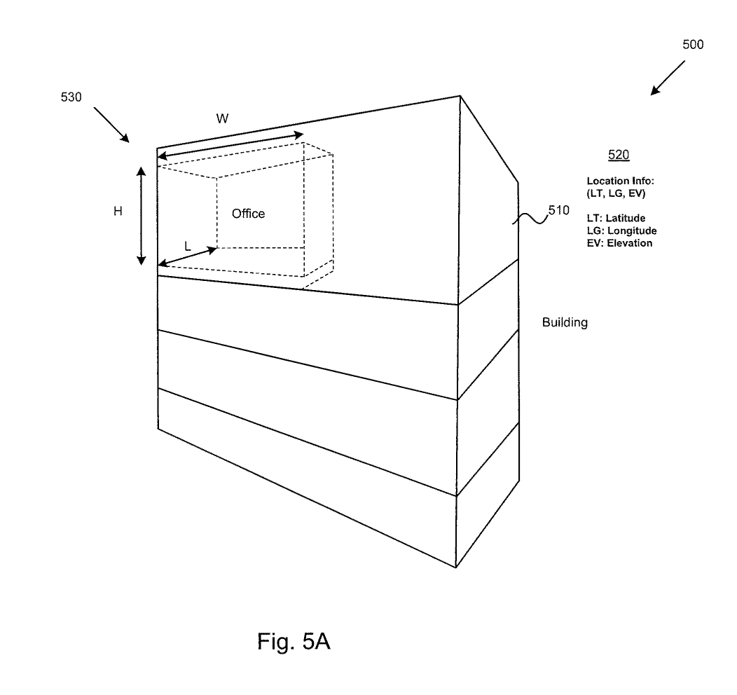

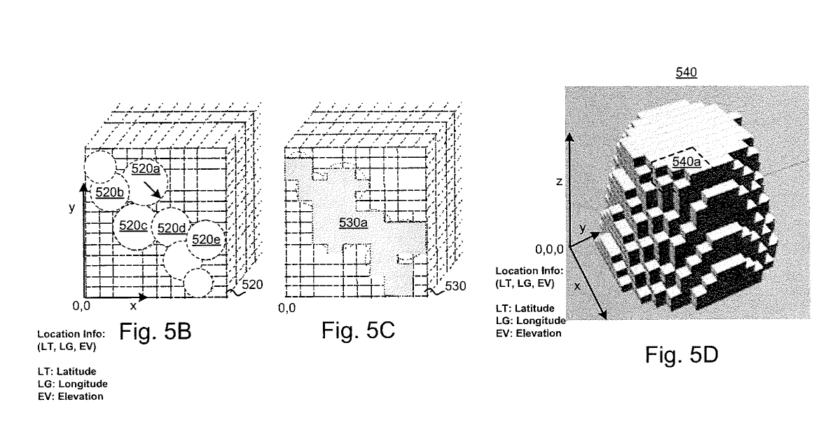

FIG. 5A depicts an exemplary spatial access boundary (530), which may be defined by an arbitrary physical shape with at least two dimensional (2D) physical measurements in direct reference to designated location coordinates information (520) to access an encrypted object according to an embodiment.

For example, certain privileged corporate information (i.e., object) may be made accessible only to an executive level officer, whose office may be located on a certain level in building 510. In this regard, spatial access boundary information (530) may be included during object encryption to improve precision in defining a permissible access request location. As discussed in FIG. 3, the permissible access range to access the encrypted object may be defined by the resolution of the received location coordinates (LT, LG, EV) information (520). The more significant places is used after the decimal of the received location coordinates (LT, LG, EV) information (520), the smaller the access range. Without adding undue cost or circuit size to a querying device such as a smart phone, most GPS receivers may have an inaccuracy of about 10 meters for latitude LT and longitude LG coordinates, while the elevation (EV) coordinates inaccuracy may be even greater.

It is expected that the future GPS receivers commonly used may provide greater accuracy down to a few meters. In whatever GPS location coordinates accuracy is provided, an enhanced protection in accessing an encrypted object may be achieved by further limiting that the request access be made within a spatial access boundary (530) which is defined by an arbitrary physical object shape, with at least two dimensional (2D) physical measurements in direct reference to designated location coordinates (LT, LG, EV) information (520) as the origin.

For example, the encrypted object (e.g., privileged corporate information) may include the spatial access boundary (530) (i.e., arbitrary physical object shape) information of an executive officer's room. In this regard, the spatial access boundary (530) may be simply defined by the three dimensional (3D) physical measurements: width (W), length (L) and height (H). The 3D physical measurements may be referenced to an origin at the designated location coordinates (LT, LG, EV) information (520), or reference to any offset from the origin.

FIG. 5B-5C depicts several exemplary spatial access boundaries, which are defined by an arbitrary physical object shape with two dimensional (2D) physical measurements in direct reference to designated location coordinates information to access an encrypted object according to an embodiment.

For example, plane (520) in FIG. 5B may represent a certain floor level of a building. It may be decided that an encrypted object may include spatial access boundary information, where the spatial boundary may be formed by an arbitrary physical object shape formed by circular areas (520a) to (520e). In this regard, each of the circular areas (520a) to (520e) may represent a permissible request access area using a same encryption key or using a group of respective distinct encryption keys for each circular area (520a) to (520e). Each of the circular areas (520a) to (520e) has a respective center which is offset from the origin (0,0), and with respective radius measured from the respective centers. The origin (0,0) may be the location coordinates (LT, LG, EV) information.

In another embodiment, plane (530) in FIG. 5C may represent a certain floor level of a building. It may be decided that an encrypted object may include spatial access boundary information, where the spatial boundary may be formed by an arbitrary physical object shape of a polygon (530a) formed by overlapping rectangles and/or circles. In this regard, within the polygon (530a) area may represent a permissible request access area which may be defined with a plurality of x coordinates and y coordinates measured from the origin (0,0), and overlapping with circles with respective centers offset from the origin (0,0) and respective radii from the respective centers. The origin (0,0) may be the location coordinates (LT, LG, EV) information.

The polygon spatial access boundary (530a) may be encrypted with a single encryption key for the object. Alternately, a group of distinct encryption keys (sharing the same LT, LG, EV) may be used to encrypt a respective individual square or circle within the polygon spatial access boundary (530a).

FIG. 5D depicts an exemplary spatial access boundary (540a), which is defined by an arbitrary physical object shape with three dimensional (3D) physical measurements in direct reference to designated location coordinates information to access an encrypted object according to an embodiment. The physical object in FIG. 5D may be an architecture outline of a building (540). It may be decided that an encrypted object may include 3D spatial access boundary information (540a), which the spatial boundary may be formed by an arbitrary 3D physical object shape, such as a particular corner office at the top floor of the building (540). Accordingly, the encrypted object may be accessed when a request is made within the 3D spatial boundary information (540a) which may be referenced to the location coordinates (LT, LG, EV) information as the origin (0,0,0).

In an embodiment, the 3D spatial boundary information (540a) may be actual physical measurements or measurements from an architecture blueprint. Alternately, the physical measurements of the arbitrary physical object may be mathematically generated from a numerical solid model, such as from an AutoCad® file or other equivalent programs with sophisticated algorithms to generate a 3D arbitrary physical object shape. The 3D spatial boundary information (540a) may be referenced to the location coordinates (LT, LG, EV) information as the origin (0,0,0).

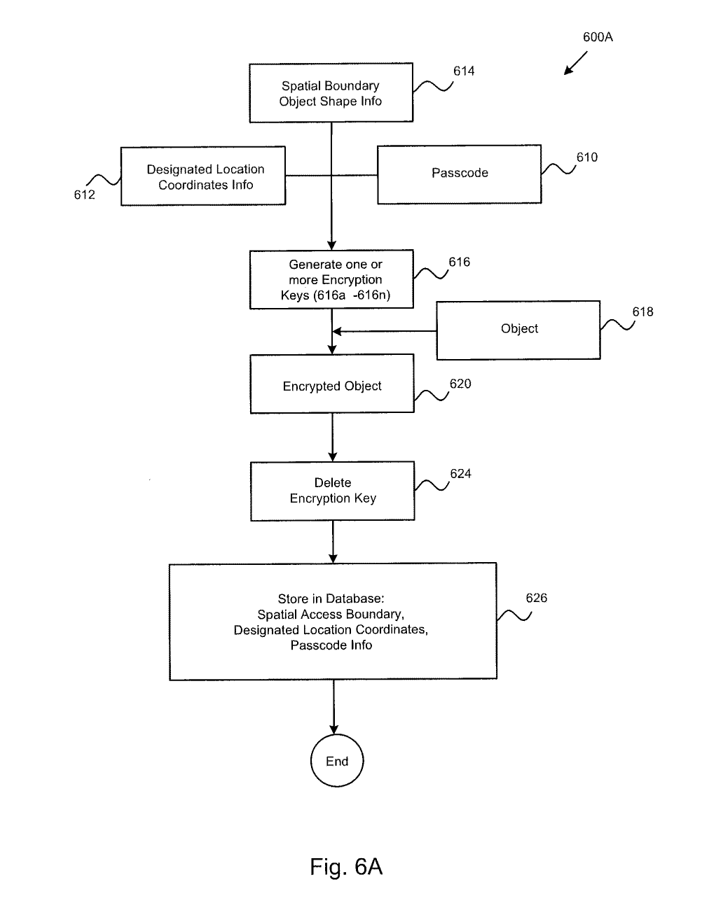

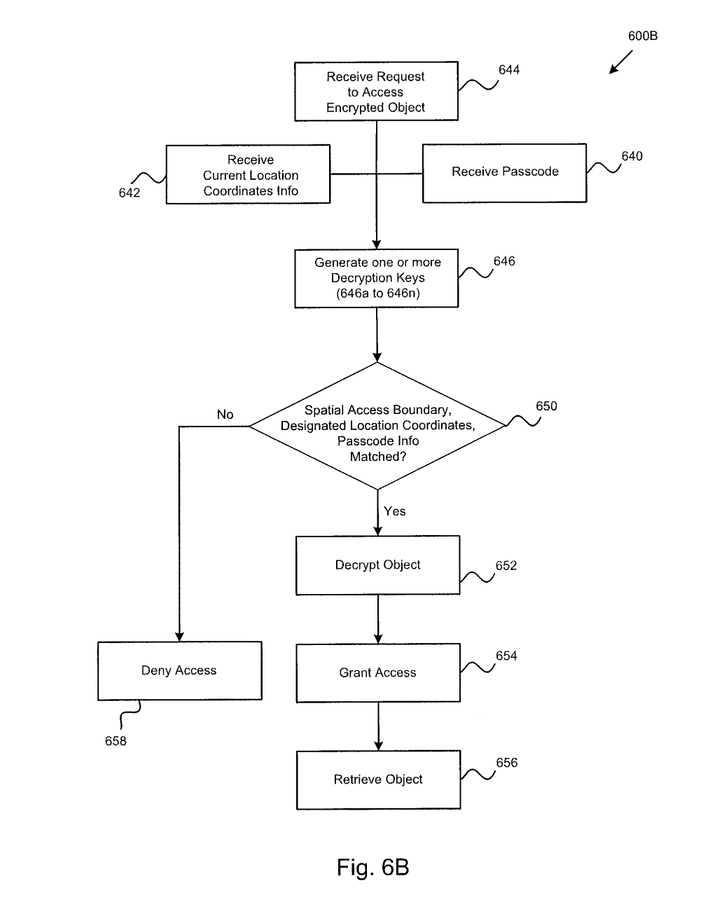

FIG. 6A is a flow chart, which depicts exemplary steps for encrypting an object based on at least designated location coordinates information and spatial boundary object shape information, according to an embodiment of the present disclosure. In general, the operations performed in FIG. 6A may be performed by at least one processor (262) coupled to a memory (264) and to a ciphering module (270) within a server (260) as depicted in FIG. 2B.

Yet, in an embodiment, all the steps in FIG. 6A may also be carried out on the exemplary querying device (250) itself, where the querying device may be a smart phone, a smart tablet, a laptop computer, a server, any electronic widget, a handheld game device, a network device, a vault, a test instrument, a smart weapon, a piece of equipment or a machine.

Referring to FIG. 6A, a new encryption key (616) may be generated from at least a passcode (610) and designated location coordinates (LT, LG, EV) information (612), and preferably, also the spatial boundary object shape information (614). In other words, the newly generated key may be at least location and shape based, in addition to the passcode information.

The passcode may use one or more of: user ID, user password, randomly generated number, a device ID, device type, a WiFi access point service set identifier (SSID), equipment ID number (EIN), an RFID tag code, network IP address, device IP address, magnetic codes, graphical image data, image pattern data, optical scan codes, or user's biometric data (physical biometric data or behavioral biometric data).

The designated location coordinates (LT, LG, EV) information (612) may include latitude coordinates (LT), longitude coordinates (LG) and elevation coordinates (EV), which may be programmed or configured to designate one or more permissible access location. Alternately, the designated location coordinates (LT, LG, EV) information (612) may be received via a GPS receiver.

The spatial boundary object shape information (614) may be defined by an arbitrary physical object shape, which may be generated using one or more mathematical models or from actual measurements. In addition, the spatial boundary object shape information (614) may include 2D information or 3D information. Depending on precision needs, an arbitrary physical object in 2D or 3D may be generated with numerous smaller geometric objects using known best fit algorithms or finite element algorithms.

In addition, an arbitrary physical object in 2D or 3D may be scaled up or scaled down to any arbitrary reduced size to gain any level of precision. In this regard, fine grain access control may be achieved using numerous small objects which may enable an encrypted object to be accessed with a valid generated encryption key (616a) at a certain portion of a hallway, while the same generated encryption key (616a) may be invalid at a neighboring portion of the same hallway.

The generated encryption key (616a) may also include one or more of time coordinates such as access time duration, start and end dates, start and end time of a day, time lapse between accesses of the encrypted object, how frequent the encrypted object may be allowed to be accessed, a designated time of the day, or designated days of the week for access, etc. In addition, the time information may reference to one of the time zones in a certain country, or may reference to a Universal Time Coordinate (UTC), also known as Greenwich Mean Time (GMT). In this regard, the newly generated encryption key (616) may also be time coordinate based.

An encrypted object (618) such as an electronic document, an executable file, multimedia data, a database or a user interface, may be encrypted with the generated encryption key (616a) to form an encrypted object (620). In this regard, the encrypted object (620) may be accessed only when all the encrypted parameters (i.e., user ID, passcode, location coordinates information, spatial access boundary information, time coordinates, etc.) defined in the generated encryption key (616a) have been met.

In another embodiment, the encrypted object (620) may also be encrypted with a group of generated encryption keys (616a to 616n), where the group of generated encryption keys (616a to 616n) may share the same designated location coordinates (LT, LG, EV) information. However, the generated key (616a) may differ from the generated key (616b) within the group by having different designated spatial access boundaries (which are defined by arbitrarily physical object shapes mathematically generated and referenced to the designated location coordinates (LT, LG, EV) as the origin). For example, a generated key (616a) may be designated to a square area within the generated arbitrarily physical object shape and another generated key (616b) may be designated to another square or to a circle within the group of generated arbitrarily physical object shapes.

Referring back to FIGS. 5B to 5D, the group encryption keys (616a to 616n), may represent a designated spatial access boundary (a set of squares, circles or any arbitrary physical shape that covers a building mathematically defined by a best fit algorithm, for example). Each encryption key (616a, 616b . . . 616n) may open an encrypted object (e.g., an electronic document) located in the same received GPS coordinates (LT, LG, EV), but in only one of the squares or circles as a valid encryption key.

Each of the group encryption keys (616a to 616n) may be setup and defined as a the list of allowed locations (Loc₁, Loc₂, Locₙ), where Loc₁ could be a tuple of latitude (LT) and longitude (LG), or a triple of latitude (LT), longitude (LG), and elevation (EV). In this regard, the list of allowed locations (Loc₁, Loc₂, Locₙ) may be used to set up group encryption keys (616a to 616n).

An encrypted object (620) may be associated with an encryption key (616a) parameter may be defined as: Enc(Enc Group Key)=Object*

Likewise, a reverse process may be used to decrypt the encrypted object using a constructed decryption key (to be discussed in FIG. 6B): Dec(Dec Member Keyᵢ, Object*)=Object

In step (620), once the object (618) has been encrypted with one or more of the generated encrypted keys (616a to 616n), the information of the one or more generated encrypted keys (616a to 616n) may be deleted, or alternately stored in a server or a database. In step (626), the encrypted object (620) (with the encrypted parameters of: spatial access boundary, designated location coordinates and passcode) may be stored in a server (such as server 140a or 140b in FIG. 1) or externally in a database (such as database 130 in FIG. 1).

FIG. 6B is a flow chart, which depicts exemplary steps for accessing an encrypted object based on at least designated location coordinates information and spatial access boundary information, according to an embodiment of the present disclosure. In general, the steps performed in FIG. 6B may be referred to a server (140a or 140b) in conjunction with a database (130) as shown in FIG. 1.

Alternately, the decryption key generation steps (640, 642, 646) may optionally be carried by at least one processor (222) and a ciphering module (240) within a querying device (such as querying device (150a) in FIG. 1 or device (250) in FIG. 2A), where a request to access an encrypted object is made.

Yet, in another embodiment, all the steps in FIG. 6B may be carried out on the querying device itself. For example, the encrypted object may be stored within the querying device may be a smart phone, a smart tablet, a laptop computer, a server, any electronic widget, a handheld game device, a network device, a vault, a test instrument, a smart weapon, a piece of equipment or a machine.

Referring to FIG. 6B, a new decryption key (646) may be generated after receiving from a querying device (250) at least a passcode (640) and received location coordinates (LT, LG, EV) information (642). The generated decryption key (646) may be sent as part of an encrypted object access request message to an authenticating server for authentication or decryption processing.

Typically, the received passcode (640) would be those which have been used to generate the one or more generated encryption keys (616a to 616n) as described in FIG. 6A. For example, the passcode (640) may be one or more of: user ID, user password, randomly generated number, a device ID, device type, a WiFi access point service set identifier (SSID), equipment ID number (EIN), an RFID tag code, network IP address, device IP address, magnetic codes, graphical image data, image pattern data, optical scan codes, or user's biometric data (physical biometric data or behavioral biometric data).

The received location coordinates (LT, LG, EV) information (642) may be received by the GPS receiver (220) within the querying device (250), or received from a proximal network device, such as a base station or an access point.

In step (648), upon receiving the encrypted object access request message, the server may retrieve the encryption key information internally or from an external database, and perform a matching step (650). The matching step (650) may be performed using one or more mapping algorithms to: match the received passcode (640) with the encrypted object passcode (610) stored in the server or database, determine whether the received location coordinates (LT, LG, EV) information (642) lies within the designated location coordinates (LT, LG, EV) information (612).

Assuming that the received passcode (640) matches the encrypted object passcode (610), and that the received location coordinates (LT, LG, EV) information (642) lies within the designated location coordinates (LT, LG, EV) information (612), the matching step (650) may further determine which of the encryption keys (616a to 616n) may be used to further match the decryption key (646), based on the spatial access boundary (614) defined by the encrypted object (620). For example, if the received location coordinates (LT, LG, EV) information (642) lies within a circular spatial access boundary (an arbitrary physical object shape with 2D physical measurements) which is encrypted with the encryption key (616b), and if the decryption key (646) matches the encryption key (616b), then the requested encrypted object (620) may be decrypted (step 652). Accordingly, access may be granted (step 654) and the (decrypted) object (618) may be retrieved into the querying device, or optionally downloaded into another proxy device which further processes the object (618) (step 656). Otherwise, the access to the object (618) may be denied (step 658).

The following illustrates an exemplary embodiment to encrypt an object (618) at a single location using time coordinates and location coordinates. The object (618) may be encrypted with at least the following encryption vectors using hash functions. A hash is a mathematical operation to embed one or more parameters into an encryption key K*.

For single allowed location:

Encryption key K*=Hash (Passcode K, Truncated GPS coordinates)

For single allowed time:

Encryption key K*=Hash (Passcode K, Time coordinates)

For single allowed location and time:

Encryption key K*=Hash (Passcode K, Truncated GPS coordinates, Time coordinates)

Additional parameters may be added to the encryption key K* to personalize it. For example:

Encryption key K*=Hash (Passcode K, Truncated GPS coordinates, Time coordinates, device type*, EIN, device id, user name or id, etc.)

The following illustrates an exemplary embodiment to encrypt an object (618) at multiple locations using time coordinates and location coordinates. Two exemplary approaches may be illustrated:

a) Approach 1:
i. In the system initiation time, define the allowed locations for object O-Loc₁, Loc₂, . . . , Locₖ.
ii. Generate a master encryption key MK to encrypt the object O, where MK have k encrypted versions for usage at k locations (i.e., group keys).
iii. Generate: MK₁=Enc(MK, Hash(K, Loc₁)), . . . , MKₖ=Enc(MK, Hash (K, Locₖ₎₎
iv. Decrypt object O, using the passcode K and Locᵢ,
   First define: Dec(MKᵢ, Hash (K, Locᵢ))=MK, then use MK to decrypt O

b) Approach 2:
i. Assume there is an algorithm F and F′, one may use F and F′ to create group keys to encrypt and decrypt an object O.
ii. Define algorithm: F(O, Loc₁, Loc₂, . . . , Locₖ)=O*, where for any i, 1≦i≦k, F′(O*, Locᵢ)=O

More information regarding the above F and F′ algorithm or functions may be found from the publication by A. Kiayias, Y. Tsiounis, and M. Yung. “Group Encryption”. ASIACRYPT 2007, LNCS 4833, PP 181-199, 2007.

A table below may be provided to generalize an exemplary formula for the encryption examples applicable to the above illustrated figures and related paragraphs.

| | |
|---|---|
| Key Generation | Key Set* ← KeyGen(Location, Duration) |
| Create an object | Encrypted Object ← Enc(Obj, EncKey*) |
| Decrypt an object | Decrypted Object ← Dec(Encrypted Obj, DecKeyᵢ*) |
| Location Info | Location ← Function(Shape, a set of coordinates or |
| | parameters) or |
| | Location ← Function(identity of authorized access |
| | points) |
| Duration Info | Duration ← Function(start date, end date, start time, |
| | end time, frequency) |

Wherein the Key Set* is composed of an encryption key (i.e., EncKey*), and a series of decryption keys (i.e., DecKey, (1 <= i <= k)).

The key generation algorithm (i.e., KeyGen), may employ other standard key generation algorithm as its basis such as the methods just described in the previous paragraphs above, or optionally, it may also be an all-new algorithm such as the F and F′ algorithm.

It should be pointed out that the disclosure described above, namely, the method and system for object access and usage control using location and access boundary shape information, provide additional security for an authorized object access. In addition, the disclosure provides flexibility which enables the object to be accessed in multiple locations, yet extending fine grain control to restrict object access to within a confined spatial access boundary. Furthermore, the object may be dynamically encrypted by dynamically reconfiguring anyone of: its designated location coordinates information, redefining the arbitrary physical object shape of the spatial access boundary in 2D or in 3D, or specifying time parameters or equipment ID, etc. In this regard, tight control over inadvertent information dissemination or hacking by unauthorized users at a remote location or outside the spatial access boundary may be prevented.

Those of ordinary skill in the art should understand that all or a part of the steps in the method according to the embodiments of the present disclosure can be implemented by a program instructing relevant hardware, and the program may be stored in a non-transitory computer readable storage medium, such as a ROM/RAM, a magnetic disk, or an optical disk, which are executed in a machine, such as an end-user mobile device, in a server, or cloud computing infrastructure.

It will be apparent to those skilled in the art that various modifications and variations can be made to the present disclosure without departing from the scope or spirit of the disclosure. In view of the foregoing, it is intended that the present disclosure cover modifications and variations of this disclosure provided they fall within the scope of the following claims and their equivalents.

1. A method for controlling access to an object by a querying device having at least one processor coupled to a memory, the at least one processor performing:
receiving location coordinates information of the querying device;
requesting an access to the object in accordance to the received location coordinates information;
granting or denying access to the object based on a determination of whether the received location coordinates information lies within at least one spatial access boundary, wherein:
the at least one spatial access boundary is defined by an arbitrary physical object shape with at least two dimensional (2D) physical measurements, wherein the at least 2D physical measurements are in direct reference to designated location coordinates information, wherein the received location coordinates information and the designated location coordinates information each comprises longitude, latitude and elevation values; and
restricting access according to frequency of access to the object.

2. The method according to claim 1, wherein the arbitrary physical object shape is generated using one or more mathematical models or from actual measurements.

3. The method according to claim 1, wherein the arbitrary physical object shape is three dimensional (3D).

4. The method according to claim 1, wherein the object is associated with an encryption key, and the determination comprising matching a decryption key to the encryption key, and wherein the decryption key is generated from entering into the querying device, one or more of: a randomly generated number, a device identification (device ID), device type, a WiFi access point service set identifier (SSID), equipment ID number (EIN), an RFID tag code, network IP address, device IP address, magnetic codes, graphic image data, image pattern data, optical scan codes, or user's biometric data.

5. The method according to claim 1, wherein the querying device is a mobile wireless communication device, a smart phone, a personal digital assistant (PDA) device, a communication tablet device, a laptop computing device or a communication device connected to a network.

6. The method according to claim 1, wherein the at least one spatial access boundary is defined by specifying a predetermined radius distance originated from the designated location coordinates information.

7. The method according to claim 1, wherein the at least one spatial access boundary is defined by truncating any one of the coordinates of the designated location coordinates information.

8. The method according to claim 1, further comprising restricting access according to time duration, wherein the time duration comprises at least one of: start and end dates, start and end time of a day, or time lapse between accesses of the object.

9. The method according to claim 1, wherein the at least one spatial access boundary comprises multiple discrete spatial access boundaries, wherein each of the multiple discrete spatial access boundaries references to the designated location coordinates information and wherein the granting or denying access to the object is based on determining whether the received location coordinates information lies within a corresponding one of the multiple discrete spatial access boundaries.

10. The method according to claim 1, wherein the object comprises at least one of: an electronic document, an executable file, executable codes, multi-media content, a storage, a database, a network device, a machine, an appliance, a processor or an equipment.

11. A device for controlling access to an object, the device comprises:
a querying circuit having at least one processor coupled to a first memory, wherein the at least one processor is configured to:
receive location coordinates information;
receive a request for access to an object based on the received location coordinates information;
grant or deny access to the object based on a determination of whether the received location coordinates information lies within at least one spatial access boundary, wherein:
the at least one spatial access boundary is defined by an arbitrary physical object shape with at least two dimensional (2D) physical measurements in direct reference to designated location coordinates information, and wherein the received location coordinates information and the designated location coordinates information each comprises longitude, latitude and elevation values; and
restrict access according to frequency of access to the object.

12. The device according to claim 11, wherein the arbitrary physical object shape is generated using one or more mathematical models or from actual measurements.

13. The method according to claim 11, wherein the arbitrary physical object shape is three dimensional (3D).

14. The device according to claim 11, wherein the object is associated with an encryption key, and the determination comprising matching a decryption key to the encryption key, and wherein the decryption key is generated from entering into the querying device, one or more of: a randomly generated number, a device identification (device ID), device type, a WiFi access point service set identifier (SSID), equipment ID number (EIN), an RFID tag code, network IP address, device IP address, magnetic codes, graphic image data, image pattern data, optical scan codes, or user's biometric data.

15. The device according to claim 11, wherein the device is a mobile wireless communication device, a smart phone, a personal digital assistant (PDA) device, a communication tablet device, a laptop computing device or a communication device connected to a network.

16. The device according to claim 11, wherein the at least one spatial access boundary is defined by specifying a predetermined radius distance originated from the designated location coordinates information.

17. The device according to claim 11, wherein the at least one spatial access boundary is defined by truncating at any one of the coordinates of the designated location coordinates information.

18. The device according to claim 11, wherein the at least one processor is configured to restrict access according to time duration, wherein the time duration comprises at least one of: start and end dates, start and end time of a day, or time lapse between accesses of the object.

19. The device according to claim 11, wherein the at least one spatial access boundary comprises multiple discrete spatial access boundaries, wherein each of the multiple discrete spatial access boundaries references to the designated location coordinates information and wherein the granting or denying access to the object is based on determining whether the received location coordinates information lies within a corresponding one of the multiple discrete spatial access boundaries.

20. The device according to claim 11, wherein the object comprises at least one of: an electronic document, an executable file, executable codes, multi-media content, a storage, a database, a network device, a machine, an appliance, a processor or an equipment.

21. A method for generating an encryption key for an object by at least one processor coupled to a first memory, the at least one processor performing:
receiving designated global positioning system (GPS) location coordinates;
receiving at least one spatial access boundary information, wherein:
the at least one spatial access boundary information is defined by an arbitrary physical object shape with at least two dimensional (2D) physical measurements in direct reference to the designated GPS location coordinates, and wherein the designated GPS location coordinates comprises longitude, latitude and elevation values;
receiving a time coordinate comprising frequency of access to the object;
generating the encryption key utilizing at least the designated GPS location coordinates, the time coordinate and the at least one spatial access boundary information;
storing the encryption key in a secured memory; and
associating the encryption key to an object, wherein the object is stored in a second memory.

22. The method according to claim 21, wherein the arbitrary physical object shape is generated using one or more mathematical models or from actual measurements.

23. The method according to claim 21, wherein the arbitrary physical object shape is three dimensional (3D).

24. The method according to claim 21, wherein the at least one spatial access boundary comprises multiple discrete spatial access boundaries, wherein each of the multiple discrete spatial access boundaries references to the designated location coordinates information, and wherein the generating of the encryption key comprising:
generating a plurality of encryption group key sets as group member decryption keys, wherein each group member decryption key is associated to a corresponding one of the multiple discrete spatial access boundaries.
